(19) United States
(12) Patent Application Publication
(10) Pub. No.: US 2012/0120008 A1
(43) Pub. Date: May 17, 2012

(54) VIBRATING MOTOR AND ELECTRONIC DEVICE

(76) Inventor: Koji Mori, Kanagawa (JP)

(21) Appl. No.: 13/254,583

(22) PCT Filed: Nov. 9, 2009
(86) PCT No.: PCT/JP2009/069031

§ 371 Date: Nov. 14, 2011

(30) Foreign Application Priority Data
Mar. 9, 2009 (JP) 2009-054692

(51) Int. Cl. G06F 3/041; H02K 33/16; H02P 3/10

(52) U.S. Cl. 345/173; 318/377; 318/114

(57) ABSTRACT

Provided are a vibrating motor with long life wherein vibration of the vibrating motor can be converged instantaneously, and an electronic device. Upon receiving an input signal from the operating section (5) of a touch panel, an electronic device (1) feeds a drive current (A) to a vibrating motor (7) and gives a sense of operation by vibrating the vibrating motor, wherein a brake current (B) is fed in the reverse direction after the vibrating motor (7) is driven by feeding the drive current (A) thereto and the vibrating motor (7) is damped thus converging vibration of the vibrating motor instantaneously.

### TECHNICAL FIELD

The present invention relates to a vibrating motor, and to an electronic device including the vibrating motor.

### BACKGROUND ART

Generally, a cylinder-type vibrating motor, in which a rotational axis with a weight (vibrator) fixed thereto is rotationally driven to generate vibration, and a coin-type vibrating motor, in which an eccentric armature (vibrator) is rotationally driven to generate vibration, are well known.

Such a vibrating motor is installed in various electronic devices such as a cellular telephone device and a controller of a gaming machine; and for example, the cellular telephone device is vibrated by the vibrating motor upon receiving an incoming signal, and the controller is vibrated in accordance with functions of the gaming machine.

On the other hand, in recent years, in portable electronic devices operated via a touch panel, a feel of operation is hard to obtain via such a touch panel; therefore, it is desired that a feel of operation can be imparted.

Against such a background, Patent Document 1 discloses that, in order to impart a feel of operation on a touch panel, when an operational input is made on the touch panel, a vibrating motor is driven to provide vibration to an electronic device. Although a vibrator is reciprocated in the vibrating motor of Patent Document 1, such reciprocation of the vibrator is braked by way of a friction member that touches the vibrator.

Moreover, Patent Document 2 discloses that a weight of a vibrating motor collides with an obstacle member to brake the vibrating motor installed in an electronic device.

Patent Document 1: Japanese Patent No. 3,949,912

Patent Document 2: Japanese Unexamined Patent Application, Publication No. 2003-228453

### DISCLOSURE OF THE INVENTION

### Problems to be Solved by the Invention

On the other hand, in a rotational axis with a weight attached thereto and/or an eccentric armature, an inertial force will act thereon once a vibrating motor is driven, and a predetermined period of time will be required until the driving (vibration) is converged, bringing about a problem that a distinct feel of operation is hard to obtain.

Particularly in a case in which vibration is provided each time an operational input is made in a mail input operation in a cellular phone, since such an operational input is performed in a short time, so-called “sharp” and distinct vibration is desired in which the vibration quickly converges.

Whereas, in the technique disclosed in Patent Document 1, since the friction member abuts with the vibrator, there is a problem that abrasion reduces the lifespan.

Moreover, a driving force greater than a coefficient of static friction with the friction member is required when driving, bringing about a problem that high electric power is required when driving.

In the technique disclosed in Patent Document 2 as well, since the reciprocating vibrator is braked by way of collision with the obstacle member, there is a problem that mechanical degradation occurs due to the collision and reduces the lifespan, similarly to the case of Patent Document 1.

Accordingly, an object of the present invention is to provide a vibrating motor and an electronic device, in which vibration of the vibrating motor can be instantly converged, and a lifespan thereof is long.

### Means for Solving the Problems

A first aspect of the present invention is a vibrating motor that is vibrated by rotationally driving a vibrator having an eccentric load, in which a driving current is applied to rotationally drive the vibrator, and an electric current in an opposite direction is subsequently applied to brake rotation of the vibrator.

In the first aspect of the present invention, voltage of the driving current applied to the motor is preferably equivalent to voltage of the electric current in the opposite direction, and a period of time for applying the electric current in the opposite direction is preferably shorter than a period of time for applying the driving current.

A second aspect of the present invention is an electronic device that includes: a vibrating motor that is vibrated by rotationally driving a vibrator having an eccentric load; and a driving control unit of the vibrating motor, in which, upon receiving a driving signal, the driving control unit applies a driving current to rotationally drive the vibrator, and subsequently applies an electric current in an opposite direction to brake rotation of the vibrator.

In the second aspect of the present invention, voltage of the driving current applied to the motor is preferably equivalent to voltage of the electric current in the opposite direction, and a period of time for applying the electric current in the opposite direction is preferably shorter than a period of time for applying the driving current.

A third aspect of the present invention is an electronic device that includes: an operation unit that receives an operational input; a vibrating motor that is vibrated by rotationally driving a vibrator having an eccentric load; and a driving control unit of the vibrating motor, in which, upon receiving an input signal from the operation unit, the driving control unit applies a driving current to rotationally drive the vibrator, and subsequently applies an electric current in an opposite direction to brake rotation of the vibrator.

In the third aspect of the present invention, the operation unit is preferably a touch panel, and the input signal of the operation unit is preferably a depression signal of the touch panel.

In the third aspect of the present invention, voltage of the driving current applied to the motor is preferably equivalent to voltage of the electric current in the opposite direction, and a period of time for applying the electric current in the opposite direction is preferably shorter than a period of time for applying the driving current.

In the third aspect of the present invention, the driving control unit preferably includes a first current path and a second current path connected in parallel; two switches are preferably provided in series in the first current path, and two switches are preferably provided in series in the second current path; the vibrating motor is preferably connected between the two switches in the first current path and between the two switches in the second current path; and a direction of the electric current applied to the motor is preferably changed by switching each switch.

A fourth aspect of the present invention is a vibrating motor that includes: a coil that generates a magnetic field; a vibrator facing the coil and having a magnetic pole; a spring that holds the vibrator; and a driving control unit that applies an electric current at predetermined frequency to the coil so as to drive the vibrator to reciprocate, in which the driving control unit applies a driving current at the predetermined frequency to the coil, and subsequently applies an electric current at different frequency to the coil to brake the vibrator.

A fifth aspect of the present invention is an electronic device that includes: an operation unit that receives an operational input; a coil that generates a magnetic field; a vibrator facing the coil and having a magnetic pole; a spring that holds the vibrator; and a driving control unit that applies a pulse current at predetermined frequency to the coil so as to drive the vibrator to reciprocate, in which, upon receiving an input signal from the operation unit, the driving control unit applies a driving pulse current at the predetermined frequency to the coil, and subsequently applies a pulse current at different frequency to the coil to brake the vibrator.

A sixth aspect of the present invention is a vibrating motor that includes: a coil that generates a magnetic field; a vibrator facing the coil and having a magnetic pole; a spring that holds the vibrator; and a driving control unit that applies an electric current in a predetermined phase to the coil so as to drive the vibrator to reciprocate, in which the driving control unit applies a driving current in the predetermined phase to the coil, and subsequently applies an electric current in a different phase to the coil to brake the vibrator.

A seventh aspect of the present invention is an electronic device that includes: an operation unit that receives an operational input; a coil that generates a magnetic field; a vibrator facing the coil and having a magnetic pole; a spring that holds the vibrator; and a driving control unit that applies an electric current in a predetermined phase to the coil so as to drive the vibrator to reciprocate, in which, upon receiving an input signal from the operation unit, the driving control unit applies a driving current in a predetermined phase to the coil, and subsequently applies an electric current in a different phase to the coil to brake the vibrator.

It should be noted that the pulse current at different frequency refers to, for example, a pulse current that is applied at an interval of 30 ms (milliseconds) when the frequency of the driving current is applied at an interval of 60 ms, so that the intervals for applying the pulse currents are different.

The electric current in a different phase refers to, for example, an electric current in a phase of a cosine curve that is shifted from a sine curve of a driving current.

In addition, in the present specification, the electronic device may be a cellular phone, a controller of a gaming machine, a PDA (Personal Digital Assistant), an ATM (automated teller machine), etc.

### Effects of the Invention

According to the first to third aspects of the present invention, in the vibrating motor that is vibrated by rotationally driving the vibrator having an eccentric load, a driving current is applied to the vibrating motor, and an electric current in an opposite direction is subsequently applied to brake the rotation of the motor; therefore, the driving of the vibrator can be stopped against an inertial force when driving the vibrating motor, and thus the vibration can be instantly converged.

Since no friction occurs when stopping the driving of the vibrator, deterioration due to abrasion and the like can be prevented, and a lifespan of the vibrating motor can be lengthened.

Furthermore, the lifespan of the vibrating motor can also be lengthened as a result of the vibration convergence time being short, wasteful rotations due to an inertial force being prevented, and the number of rotations of the vibrator being reduced.

According to the fourth to seventh aspects of the present invention, in the vibrating motor with the vibrator that reciprocates by way of an action of a magnetic field, a driving current at predetermined frequency or in a predetermined phase is applied to drive the vibrator, and an electric current at different frequency or in a different phase is subsequently applied to the coil to suppress an inertia force of the vibrator and stop the driving; therefore, the vibration can be instantly converged.

Since no friction occurs when stopping the driving of the vibrator, deterioration due to abrasion and the like can be prevented, and a lifespan of the vibrating motor can be lengthened.

Moreover, the lifespan of the vibrating motor can also be lengthened as a result of the fact that the vibration convergence time is short, thus wasteful rotations can be prevented, and the number of rotations of the vibrator can be reduced.

### BRIEF DESCRIPTION OF THE DRAWINGS

FIG. 1 is a graph showing control and a convergence state of a vibrating motor according to a first embodiment as compared to a conventional case, in which FIG. 1(a) shows control and a convergence state of the vibrating motor according to the first embodiment, and FIG. 1(b) shows control and a convergence state of a conventional vibrating motor;

FIG. 2 is a diagram showing a driving control unit of the vibrating motor according to the first embodiment, in which FIG. 2(a) is a plan view showing a configuration of the driving control unit, FIG. 2(b) is a circuit diagram, and FIG. 2(c) is a graph showing control operations;

FIG. 3 is a perspective view showing an electronic device according to the first embodiment;

FIG. 4 is a cross-sectional view showing a schematic configuration of a vibrating motor portion in the electronic device shown in FIG. 3;

FIG. 5 is a graph showing a relationship between acceleration and convergence time of a vibrator of the vibrating motor according to the first embodiment;

FIG. 6 is a graph showing vibration convergence time in input operations for a mail document in a cellular phone as compared with a conventional case, in which FIG. 6(a) represents the first embodiment, and FIG. 6(b) represents the conventional case;

FIG. 7 is a graph showing reliability of the vibrating motor according to the first embodiment as compared to a conventional case;

FIG. 8 is a diagram showing a control unit of a vibrating motor according to a second embodiment, in which FIG. 8(a) is a plan view showing a configuration of the control unit, and FIG. 8(b) is a circuit diagram;

FIG. 9 is a cross-sectional view showing a schematic configuration of a vibrating motor according to a third embodiment;

FIG. 10 is a graph showing a relationship between control and vibration of the vibrating motor shown in FIG. 9; and

FIG. 11 is a graph showing a modified example of the control of the vibrating motor according to the third embodiment.

### EXPLANATION OF REFERENCE NUMERALS

1 electronic device

5 operation unit

7 vibrating motor

7c weight (vibrator)

9 driving control unit

11 first current path

13 second current path

21 spring

23 magnet (vibrator)

25 coil

A driving pulse current (driving current)

B braking pulse current (braking current)

T1 period of time for applying driving current

T2 period of time for applying braking current (current in opposite direction)

Te vibration convergence time

a, b, c, d switch

### PREFERRED MODE FOR CARRYING OUT THE INVENTION

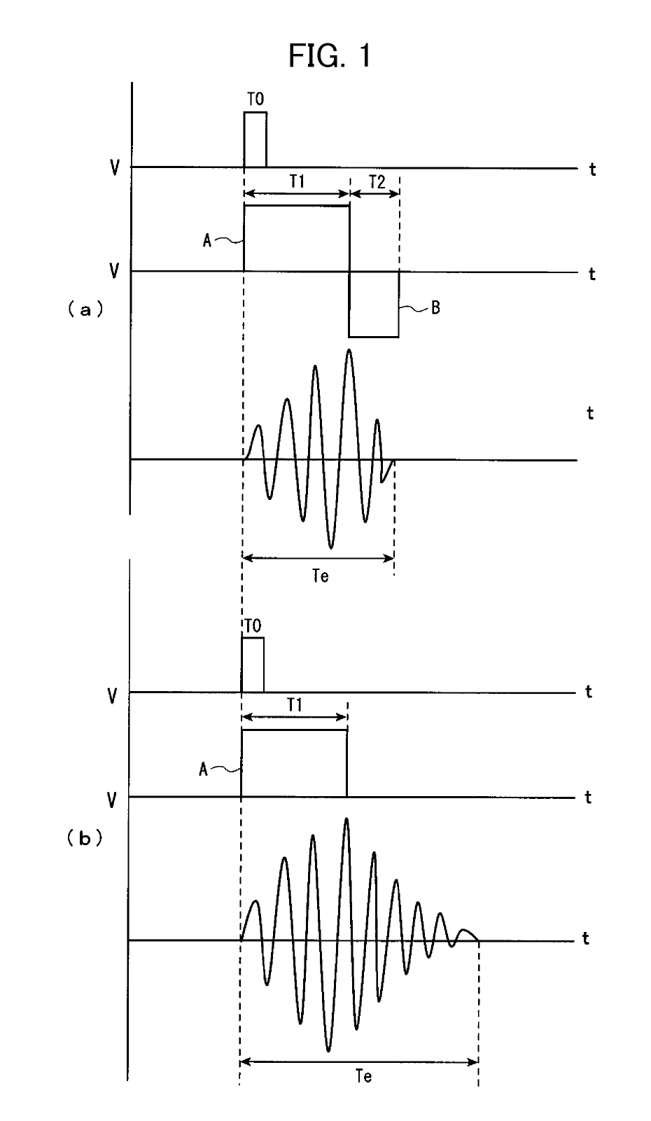

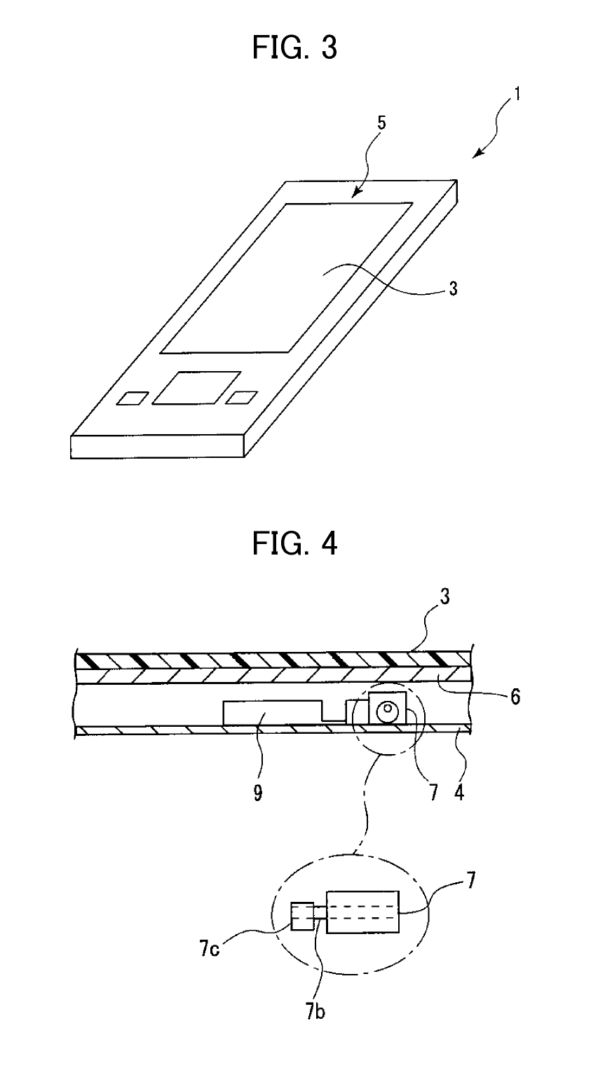

Descriptions are hereinafter provided for a first embodiment of the present invention with reference to FIGS. 1 to 7. An electronic device 1 according to the first embodiment is a cellular phone. As shown in FIG. 3, the electronic device 1 includes an operation unit 5 that is operated by way of a touch panel 3. As shown in FIG. 4, the electronic device 1 includes, inside thereof, a vibrating motor 7 on a circuit board 4; and a driving control unit 9 of the vibrating motor.

The touch panel 3 displays, for example, on a liquid crystal unit 6, buttons that indicate numeric characters, symbols, other characters, etc. for inputting telephone numbers, selecting functions, and inputting mail documents. When an arbitrary button display portion is touched by a finger, contact pressure is detected (more specifically, a resistance value, electrostatic capacity, light and the like are detected), a detecting signal is transmitted from the liquid crystal display unit 6 to the driving control unit 9, and the driving control unit 9 performs control to drive the vibrating motor 7.

An eccentric weight (vibrator) 7c is fixed to the tip of a rotational axis 7b of the vibrating motor 7, and by applying an electric current to the vibrating motor 7, the eccentric weight 7c is rotated to generate vibration in the electronic device 1.

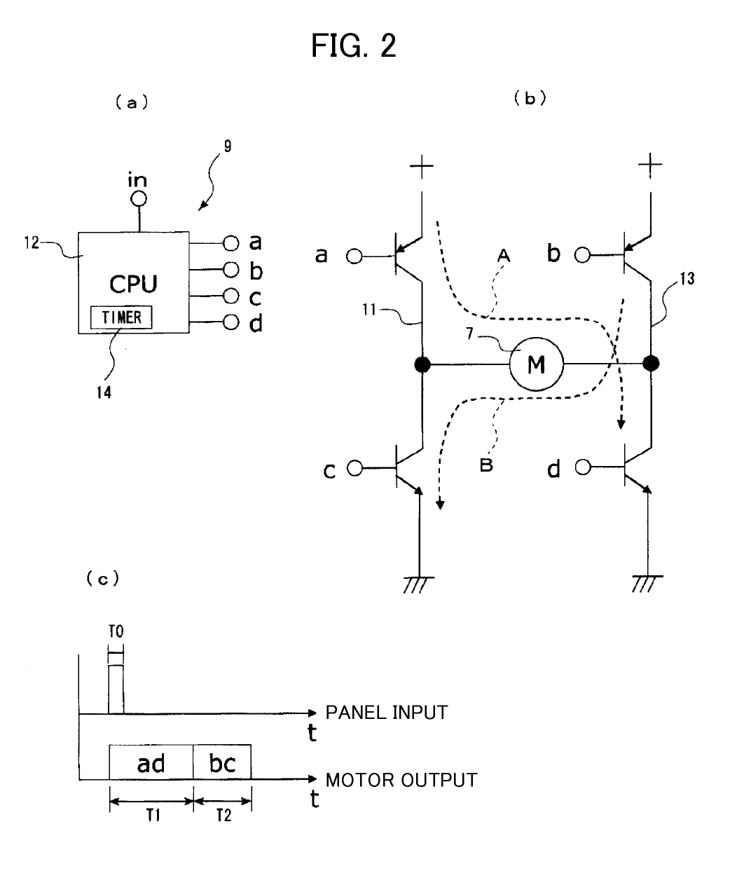

As shown in FIG. 2(a), the driving control unit 9 includes a CPU 12 and four switching units a, b, c and d. As shown in the FIG. 2(b), the four switching units are provided to a first current path 11 and a second current path 13 that are connected in parallel with an electric power supply. The switching units a and c are connected in series with the first current path 11, and the switching unit b and d are connected in series with the second current path 13. It should be noted that the electric power supply is a direct current power supply of 3V.

In addition, the vibrating motor 7 is connected between the switching units a and c in the first current path 11 and between the switching unit b and d in the second current path 13.

As shown in FIG. 2(b), with this configuration of the control unit 9, when the switching units a and d are turned on (connected), and the switching units b and c are turned off (disconnected), a driving current A is applied to rotationally drive the vibrating motor.

On the other hand, when the switching units a and d are turned off, and the switching units b and c are turned on, a braking current B is applied to the vibrating motor in a direction opposite to the driving current A, and the vibrating motor is rotationally driven in the opposite direction.

The four switching units a, b, c and d are switched as follows. When the control unit 9 receives an input signal at a portion “in” (see FIG. 2(a)) from the control panel, in the four switching units a, b, c and d that are all in an off state, as shown in FIG. 2(c), the CPU 12 turns on the switching units a and d at the same time to apply the driving current A to the vibrating motor to be driven only for a period of time T1 that is preset in a timer 14 (see FIG. 2(a)), thereafter the switching units a and d are turned off and the switching units b and c are turned on at the same time to apply the current B in the direction opposite to the driving current for a period of time T2.

Next, descriptions are provided for operations and effects of the first embodiment.

When an input is made from the operation unit 5, as shown in FIG. 1(a), the CPU 12 applies the driving pulse current A to the vibrating motor 7 to be driven for the period of time T1, and subsequently applies the braking pulse current B in the opposite direction for the period of time T2.

As a result of driving the vibrating motor 7, the rotational axis of the vibrating motor tends to keep rotating due to an inertial force, even after stopping applying the pulse current A thereto (see Te in FIG. 1(b)). However, in the present embodiment, as shown in FIG. 1(a), as a result of applying the braking pulse current B for the period of time T2 after applying the driving pulse current A for the period of time T1, the rotation of the vibrator 7c is braked, and the driving of the vibrating motor 7 is instantly stopped; therefore, it is possible to shorten rotation (vibration) convergence time Te of the vibrator 7c after stopping the driving pulse current A.

On the other hand, as shown in FIG. 1(b), in conventional cases, since the braking pulse current B is not applied, the rotational axis tends to keep rotating due to an inertial force even after applying the driving pulse current A for the period of time T1, and the vibration convergence time Te is prolonged; whereas, according to the present invention, as shown in FIG. 1(a), the vibration convergence time can be extremely shortened as compared to the conventional cases.

Here, descriptions are provided for results of an experiment conducted regarding the relationship among the period of time T1 for applying the pulse current A, the period of time T2 for applying the braking pulse current B, and the vibration convergence time Te.

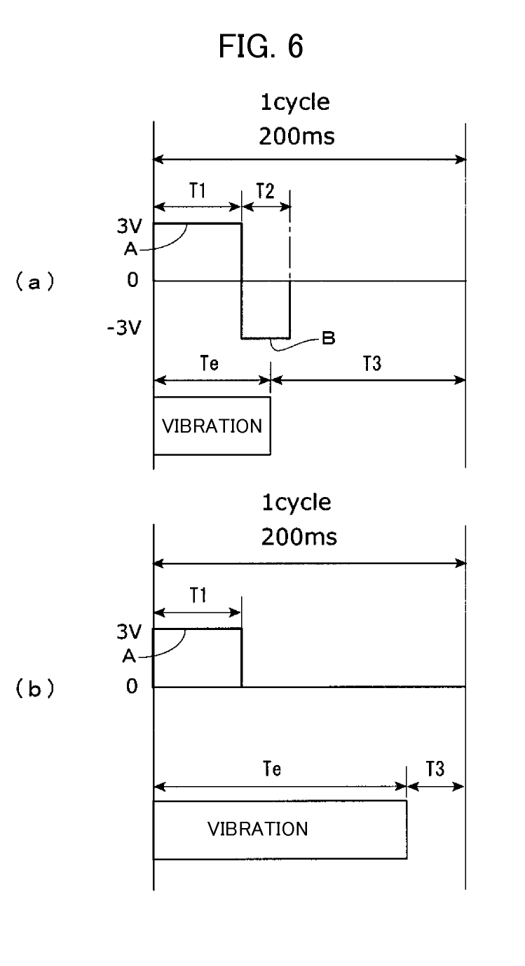

As shown in FIG. 6, for example, in a case of assuming that a mail document is created in a cellular phone, five characters may be input in a second. This case assumes that: an input of a single character takes 1 cycle, 1 cycle is 200 ms (milliseconds), the period of time T1 for applying the pulse current A is 60 ms, and the period of time T2 for applying the braking pulse current B is 30 ms. In this case, as shown in FIG. 6(a), the vibration convergence time Te of the vibrating motor was 75 ms.

On the other hand, as shown in FIG. 6(b), in a case in which the braking pulse current B was not applied, the vibration convergence time Te of the vibrating motor was 140 ms.

In other words, according to the first embodiment, the convergence time Te of the vibrating motor can be substantially a half of that in the conventional case, and sharp vibration can be imparted for each input even in a case in which five characters are input in one second. In particular, as shown in FIG. 6, an idle period of time T3 after vibration in 1 cycle (200 ms) is 125 ms in the present embodiment, and is 60 ms in the conventional case; therefore, in the present embodiment, the idle period of time T3 can be approximately double of that in the conventional case, and it is possible to prevent such vibration from overlapping with vibration of a subsequent character input.

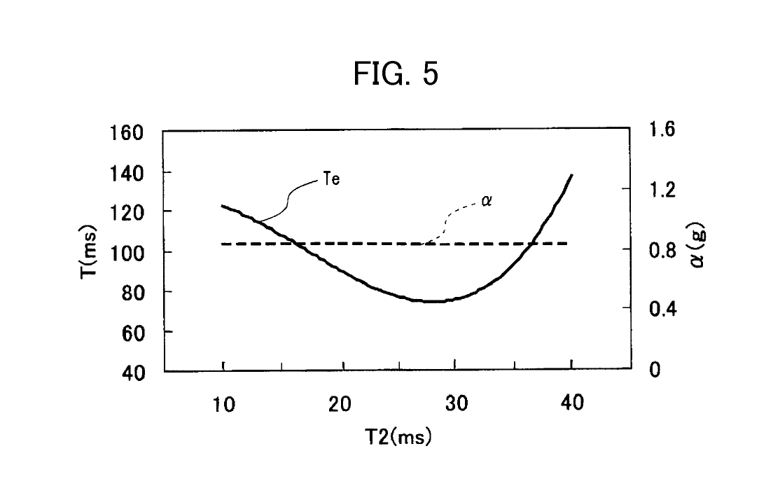

Here, an optimal period of time T2 for applying the braking pulse current B is described with reference to FIG. 5. FIG. 5 shows a result of measuring the convergence time Te in a case in which the period of time T1 for applying the driving current A was 60 ms, and the period of time T2 for applying the braking pulse current B was varied. It should be noted that the voltage was 3V, and acceleration a of the vibrator was substantially constant at 0.8 g.

As is apparent from FIG. 5, when the period of time T1 for applying the driving current A was 60 ms, the convergence time was evidently the shortest (about 75 ms) when the period of time T2 for applying the braking pulse current B was 30 ms.

In other words, in a case in which the electric voltage is constant, it is understood that the period of time T2 for applying the braking pulse current B is shorter than, and is preferably substantially a half of, the period of time T1 for applying the pulse current A.

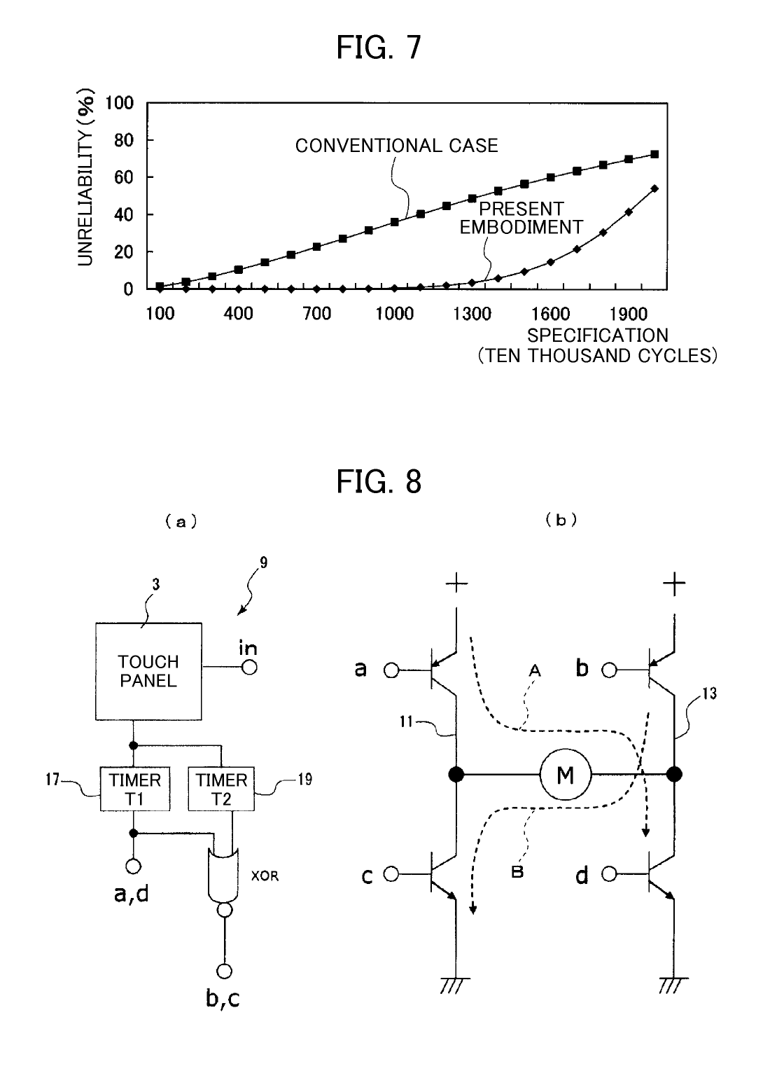

Next, a result of a lifespan test conducted for the vibrating motor is described. In the present lifespan test, unreliability was measured for a vibrating motor with brake pulse control, and a vibrating motor without brake pulse control (the conventional case). The result is described in TABLE 1 and plotted in FIG. 7.

In the present experiment, 10 samples were collected each for the vibrating motor with brake pulse control, and the vibrating motor without brake pulse control, and the sample results were obtained by calculating the Weibull distribution.

TABLE 1

| | PRESENT | CONVENTIONAL |
|---|---|---|
| LEVEL | EMBODIMENT | CASE |
| SHAPE m | 7.10 | 1.53 |
| MEAN | 1940 | 1520 |
| MTTF | | |
| FLUCTUATION σ | 320 | 1010 |
| INITIAL | 1600 | 300 |
| FAILURE | | |

(TEN THOUSAND CYCLES)

In TABLE 1, shape m denotes phenomena of failures to occur, mean MTTF denotes mean time to failure, fluctuation σ denotes fluctuation of the convergence time, and initial failure denotes the number of rotations until termination of the driving. It should be noted that a unit of each numerical value is ten thousand cycles (the number of rotations).

As is apparent from TABLE 1, in terms of the shape m, the fluctuation o and the initial failure, the vibrating motor according to the present embodiment was remarkably excellent and of high reliability as compared to the conventional case.

Although the reliability of a vibrating motor generally decreases as the number of rotations (driving period of time) increases, according to the present embodiment, as is apparent from FIG. 7, it was possible to suppress the unreliability below 1% even at the point of exceeding 10 million cycles. Therefore, it is evident that the vibrating motor 7 according to the present embodiment has a longer lifespan and higher reliability than the conventional vibrating motor does.

Another embodiment of the present invention is hereinafter described, in which the same reference numerals are assigned to portions that achieve the same operations and effects as the first embodiment, detailed descriptions thereof are omitted, and points different from the first embodiment are mainly described.

A second embodiment is described with reference to FIG. 8. In the second embodiment, when the driving control unit 9 receives an input signal from the touch panel 3, the driving control unit 9 directly applies the driving pulse current A and the braking pulse current B to the vibrating motor 7, without routing via the CPU (see FIG. 2). The driving control unit 9 includes a timer 17 for the driving pulse current A, and a timer 19 for the braking pulse current B, in which the driving pulse current A is applied for the period of time T1, and subsequently, the switching units a, b, c and d are switched to apply the braking pulse current B for the period of time T2.

According to the second embodiment, it is possible to achieve operations and effects similar to those in the first embodiment described above.

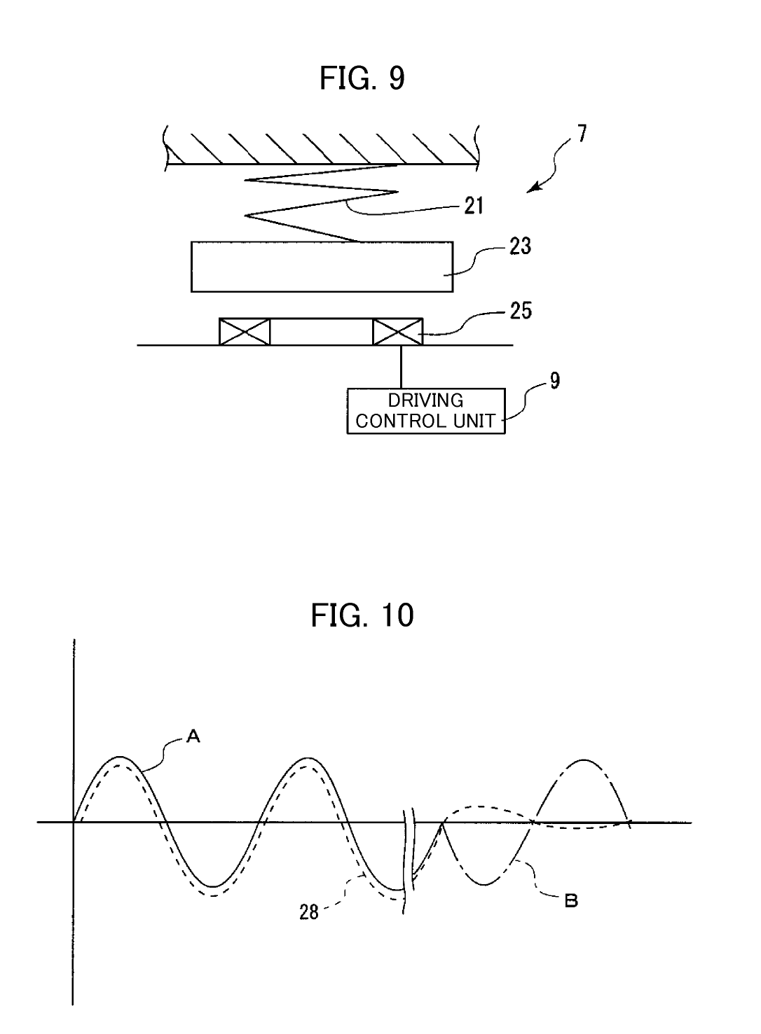

A third embodiment is described with reference to FIGS. 9 and 10. In the third embodiment, the vibrating motor 7 includes a coil 25 that generates a magnetic field that faces a magnet (vibrator) 23 attached to the spring 21, in which an electric current is applied to the coil 25 to generate a magnetic field, and the magnet 23 is vibrated by way of repulsion/attraction forces of the magnet 23 relative to the magnetic field.

In other words, in the third embodiment, the magnet 23 is vibrated in synchronization with the cycle of the driving current, and as shown in FIG. 10, the driving current A as a sine wave (phase wave) in a predetermined cycle is supplied, the magnet 23 is vibrated in synchronization with the sine wave, and cosine wave (an electric current of which phase is shifted 90 degrees) is subsequently supplied as the braking current B shown with an alternate long and short dash line in the drawing. It should be noted that a broken line 28 in FIG. 10 illustrates movement (vibration) of the magnet 23.

According to the third embodiment, the magnet (vibrator) 23 reciprocates in synchronization with the driving current A to generate vibration, and as shown in FIG. 10, when the braking current B is applied, a magnetic field is generated in a direction opposite to the direction of moving the magnet 23 (for example, a direction of moving upward when the magnet 23 moves downward); therefore, the vibration is suppressed, and the vibration of the magnet 23 is instantly converged.

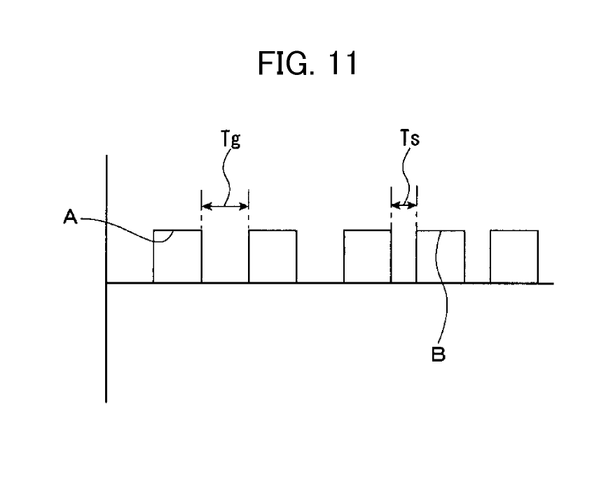

In a fourth embodiment shown in FIG. 11, the driving current A, which was applied to the coil in the third embodiment, is subsequently applied as a driving pulse current B of a rectangular wave, in which the driving pulse current A is applied in a predetermined cycle (interval) Tg to vibrate the magnet 23, and subsequently, the braking pulse current B is applied in a cycle (interval) Is that is substantially half the cycle Tg of the driving pulse current A. In other words, the driving pulse current A is in the same direction as, but shifted half a cycle of, the braking pulse current B.

According to the fourth embodiment, operations and effects similar to those in the third embodiment can be achieved.

The present invention is not limited to the aforementioned embodiments, and can be modified in various ways within a range without departing from the spirit of the present invention.

For example, the vibrating motor 7 may be an axial-void-type flat vibrating motor (coin-type vibrating motor) that is vibrated by rotating an eccentric armature (vibrator).

A second aspect of the present invention may be vibrated, for example, by receiving an incoming call signal and/or a driving signal of a cellular phone, regardless of an input from the control panel.

1-4. (canceled)

5. An electronic device comprising:
an operation unit that receives an operational input;
a vibrating motor that is vibrated by rotationally driving a vibrator having an eccentric load; and
a driving control unit of the vibrating motor,
wherein, upon receiving an input signal from the operation unit, the driving control unit applies a driving current to rotationally drive the vibrator, and subsequently applies an electric current in an opposite direction to brake rotation of the vibrator.

6. The electronic device according to claim 5, wherein the operation unit is a touch panel, and the input signal of the operation unit is a depression signal of the touch panel.

7. The electronic device according to claim 5, wherein voltage of the driving current applied to the motor is equivalent to voltage of the electric current in the opposite direction, and a period of time for applying the electric current in the opposite direction is shorter than a period of time for applying the driving current.

8. The electronic device according to claim 5,
wherein the driving control unit includes a first current path and a second current path connected in parallel,
two switches are provided in series in the first current path, and two switches are provided in series in the second current path,
the vibrating motor is connected between the two switches in the first current path and between the two switches in the second current path, and
a direction of the electric current applied to the motor is changed by switching each switch.

9. A vibrating motor comprising:
a coil that generates a magnetic field;
a vibrator facing the coil and having a magnetic pole;
a spring that holds the vibrator; and
a driving control unit that applies an electric current at predetermined frequency to the coil to drive the vibrator to reciprocate,
wherein the driving control unit applies a driving current at the predetermined frequency to the coil, and subsequently applies an electric current at different frequency to the coil to brake the vibrator.

10. An electronic device comprising:
an operation unit that receives an operational input;
a coil that generates a magnetic field;
a vibrator facing the coil and having a magnetic pole;
a spring that holds the vibrator; and
a driving control unit that applies a pulse current at predetermined frequency to the coil so as to drive the vibrator to reciprocate,
wherein, upon receiving an input signal from the operation unit, the driving control unit applies a driving pulse current at the predetermined frequency to the coil, and subsequently applies a pulse current at different frequency to the coil to brake the vibrator.

11. A vibrating motor comprising:
a coil that generates a magnetic field;
a vibrator facing the coil and having a magnetic pole;
a spring that holds the vibrator; and
a driving control unit that applies an electric current in a predetermined phase to the coil so as to drive the vibrator to reciprocate,
wherein the driving control unit applies a driving current in the predetermined phase to the coil, and subsequently applies an electric current in a different phase to the coil to brake the vibrator.

12. An electronic device comprising:
an operation unit that receives an operational input;
a coil that generates a magnetic field;
a vibrator facing the coil and having a magnetic pole;
a spring that holds the vibrator; and
a driving control unit that applies an electric current in a predetermined phase to the coil so as to drive the vibrator to reciprocate,
wherein, upon receiving an input signal from the operation unit, the driving control unit applies a driving current in a predetermined phase to the coil, and subsequently applies an electric current in a different phase to the coil to brake the vibrator.
